(19) United States
(12) Patent Application Publication
(10) Pub. No.: US 2018/0252070 A1
(43) Pub. Date: Sep. 6, 2018

(54) CONTROL OF THERMOPLASTIC COMPOSITE DEGRADATION IN DOWNHOLE CONDITIONS

(71) Applicant: SCHLUMBERGER TECHNOLOGY CORPORATION, Sugar Land, TX (US)

(72) Inventors: Shitong S. ZHU, Waban, MA (US); Miranda AMARANTE, Somerville, MA (US); Asha-Dee CELESTINE, San Fernando (TT)

(21) Appl. No.: 15/760,432

(22) PCT Filed: Sep. 7, 2016
(86) PCT No.: PCT/US2016/050461

§ 371 Date: Mar. 15, 2018

Related U.S. Application Data
(60) Provisional application No. 62/220,497, filed on Sep. 18, 2015.

(51) Int. Cl. E21B 33/138; C08J 5/04; C08L 79/08; C08L 77/02; C08L 67/00; C08K 3/22

(52) U.S. Cl. CPC E21B 33/138; C08J 5/043; C08J 5/042; C08L 79/08; C08K 2003/168; C08L 67/00; C08K 3/22; C08K 2003/2296; C08L 77/02

(57) ABSTRACT

In one aspect, compositions may include a degradable polymer composite, and methods of manufacturing polymer composites, wherein the degradable polymer composite contains a matrix formed from one or more polymers blended with one or more internal catalysts. In another aspect, methods of using a degradable polymer composite in a wellbore may include emplacing a degradable polymer composite in a wellbore traversing a subterranean formation, wherein the degradable polymer composite contains a matrix formed from one or more polymers blended with one or more internal catalysts; and contacting the degradable polymer composite with an aqueous fluid; and allowing the degradable polymer composite to at least partially degrade.

### CROSS-REFERENCE TO RELATED APPLICATION

This application claims the benefit of U.S. Application Ser. No. 62/220497, filed Sep. 18, 2015, and entitled “Control of thermoplastic composite degradation in downhole conditions”, which is incorporated herein by reference in its entirety.

### BACKGROUND

Natural resources such as gas, oil, and water residing in a subterranean formation or zone may be recovered by drilling a wellbore into a subterranean formation while circulating various wellbore fluids. During subsequent wellbore operations, numerous tools and fluids may be emplaced within the wellbore to perform a variety of functions. For example, wellbore tools such as frac plugs, bridge plugs, and packers may be used to isolate one pressure zone of the formation from another by creating a seal against emplaced casing or along the wellbore wall.

Once the wellbore is completed, production tubing and/or screens may be emplaced within one or more intervals of the formation prior to hydrocarbon production. During production operations, sand control methods and/or devices are used to prevent sand particles in the formation from entering and plugging the production screens and tubes in order to extend the life of the well.

Tools utilized in all stages of wellbore operations may be constructed from various materials suited for activities at temperatures and pressures encountered in downhole environments. Further, downhole tools may also be outfitted with specialty parts made from performance materials that are the same or different from the remainder of the tool body such as seals, chevron seals, o-rings, packer elements, gaskets, and movable parts such as slips, sleeves, and drop balls.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments of the present disclosure are directed to compositions including a degradable polymer composite, wherein the degradable polymer composite contains a matrix formed from one or more polymers blended with one or more internal catalysts.

In another aspect, embodiments of the present disclosure are directed to methods of use that include emplacing a degradable polymer composite in a wellbore traversing a subterranean formation, wherein the degradable polymer composite contains a matrix formed from one or more polymers blended with one or more internal catalysts; and contacting the degradable polymer composite with an aqueous fluid; and allowing the degradable polymer composite to at least partially degrade.

In another aspect, embodiments of the present disclosure are directed to methods of manufacture that include compounding one or more internal catalysts with one or more degradable polymer resins; and forming a degradable polymer composite by at least one of injection molding, filament winding, resin transfer molding, hand lay-up, hand spray-up, compression molding, or extrusion, wherein the degradable polymer composite contains a matrix formed from one or more polymers blended with one or more internal catalysts.

Other aspects and advantages of the invention will be apparent from the following description and the appended claims.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings.

FIG. 1 is a diagram showing the incorporation of catalysts and carbon fiber additives in accordance with embodiments of the present disclosure;

FIG. 2 is a graphical representation of thermogravimetric analysis (TGA) spectra of a polyamide/ZnCl₂ composite and glass reinforced material in accordance with embodiments of the present disclosure;

FIG. 3 is a graphical representation of differential scanning calorimetry (DSC) curves of a polyamide/ZnCl₂ composite compared with a polyamide in accordance with embodiments of the present disclosure;

FIG. 4 is a graphical representation of a Fourier transform infrared (FTIR) spectra comparing a polyamide and a polyamide/ZnCl₂ composite in accordance with embodiments of the present disclosure;

FIG. 5 is a graphical representation of weight loss percentage as a function of degradation time of the degradation of a polyamide and a polyamide/ZnCl₂ composite;

FIG. 6 is a graphical representation of TGA spectra comparing carbon and glass reinforced polyamide and AlF₃ composites in accordance with embodiments of the present disclosure;

FIG. 7 is a graphical representation of FTIR spectra comparing a polyamide and a polyamide/AlF₃ composite in accordance with embodiments of the present disclosure;

FIG. 8 is a graphical representation depicting the weight loss percentage as a function of degradation time at 150° C. for polyamide and polyamide/AlF₃ composites in accordance with embodiments of the present disclosure;

FIG. 9 is a graphical representation depicting the weight loss percentage as a function of degradation time at 98° C. for polyamide and polyamide/AlF₃ composites in accordance with embodiments of the present disclosure;

FIG. 10 is a graphical representation depicting the crystalline percentage of the polymeric matrix at 150° C. as a function of degradation for a polyamide and a polyamide/AlF₃ composite in accordance with embodiments of the present disclosure;

FIG. 11 is a graphical representation depicting DSC curves comparing a polyamide and polyamide/ZnO composites in accordance with embodiments of the present disclosure;

FIG. 12 is a graphical representation depicting TGA curves comparing a glass fiber reinforced polyamide and polyamide/ZnO composites in accordance with embodiments of the present disclosure;

FIG. 13 is a graphical representation depicting the weight loss percentage as a function of degradation time at 150° C. for polyamide and polyamide/ZnO composites in accordance with embodiments of the present disclosure; and

FIG. 14 is a graphical representation depicting the crystalline percentage of the polymeric matrix at 150° C. as a function of degradation for a polyamide and a polyamide/ZnO composite in accordance with embodiments of the present disclosure.

### DETAILED DESCRIPTION

The particulars shown herein are by way of example and for purposes of illustrative discussion of the examples of the subject disclosure only and are presented in the cause of providing what is believed to be the most useful and readily understood description of the principles and conceptual aspects of the subject disclosure. In this regard, no attempt is made to show structural details in more detail than is necessary, the description taken with the drawings making apparent to those skilled in the art how the several forms of the subject disclosure may be embodied in practice.

In one aspect, embodiments of the present disclosure are directed to degradable polymer composites that incorporate one or more internal catalysts that accelerate the degradation of the polymer when the polymer is in contact with aqueous fluids. In some embodiments, internal catalysts incorporated into a degradable polymer matrix are used to accelerate the degradation of the polymer in downhole conditions. In one or more embodiments, an acid, base, or precursor of an acid or base may be used to accelerate the degradation of a polymer composite.

In another aspect, embodiments described in the instant disclosure are directed to manufacturing processes that incorporate an internal catalyst into high strength thermoplastic composites. In some embodiments, degradable polymer composites may also contain continuous or stretch-broken fibers or other additives that modulate the structural properties and degradation rates of the degradable polymer composite.

In some embodiments, internal catalysts that may be incorporated into materials in accordance with the present disclosure include Lewis acids, metal complexes of Lewis acids, solid acids, bases, and bases precursor all show the effect of accelerating hydrolysis of the degradable polymers.

Polymers used to form the continuous polymer matrix of degradable polymer composites in accordance with embodiments of the present disclosure may have hydrolysable bonds in the backbone chain and may also be compatible with available reagents to reinforce polymers with particulates and/or fibers. In one or more embodiments, polymers may be combined with an internal catalyst to form a degradable polymer composites having polymer as the continuous phase and particulates, such as particles having an aspect ratio of 2-50, or fibers, particles having an aspect ratio >50, as the reinforcement. In embodiments containing fibers, the polymer matrix maintains fibers in the proper orientation and spacing, and protects them from abrasion and the environment. Further, in degradable polymer composites where there is a strong bond between the fiber and the matrix, the matrix transmits load to the fibers through shear loading at the interface.

In one or more embodiments, the continuous polymer matrix of the degradable polymer composite functions as the degradable phase, while the fiber reinforcing phase may provide the strength and stiffness of the composite. Continuous fibers have long aspect ratios, while discontinuous fibers (chopped sections of continuous fibers) have short aspect ratios. Continuous-fiber composites often have a preferred orientation, while discontinuous fibers generally have a random orientation. Fiber additives in accordance with the present disclosure may include glass fibers, polymer fibers, such as aramid fibers, carbon fibers, boron fibers, ceramic fibers, or metal fibers, each of which may be continuous or discontinuous. The type and quantity of the reinforcement may be used to determine the final properties in some embodiments.

Degradable polymer composites in accordance with embodiments of this disclosure may be a homogenous polymer or formulated as a blend or composite containing one or more internal catalysts, and may be used in the manufacture of downhole tools, mechanical devices, and components thereof that may be employed to divert or isolate wellbore fluids to a targeted zone within a formation. In one or more embodiments, downhole tools may include ball sealers, packers, straddle-packer assemblies, bridge plugs, frac plugs, darts, drop balls, seats, and loading tubes for perforating guns. Further, degradable polymer composites may find utility as materials for zonal isolation, bridging, plugging, or reducing fluid loss. For example, when employed as mechanically expandable bridge plugs, the plug may be emplaced through relatively small production pipes and then expanded under hydraulic pressure to plug an interval of the wellbore. In some embodiments, degradable polymer composites may be incorporated into open-hole packers as a replacement for, or in combination with, non-extrudable rubbers or elastomers, including non-degradable polymer composites such as thermoplastic vulcanizates (e.g., polyolefin-EPDM blends) and copolymers such as styrene block copolymer (SBS).

In one or more embodiments, degradable polymer composites may be used as one or more components of an inflatable packer. Inflatable packers may include an inflatable bladder to expand the packer element against the casing or wellbore to provide zone isolation. In preparation for setting the packer, a drop ball or series of tubing movements may be required, with the hydraulic pressure required to inflate the packer provided by carefully applying surface pump pressure. Inflatable packers are capable of relatively large expansion ratios, an important factor in through-tubing work where the tubing size or completion components can impose a size restriction on devices designed to set in the casing or liner below the tubing.

In some embodiments, degradable polymer composites may also be incorporated into swellable packers. Swellable packers in accordance with embodiments disclosed herein include packers used with or without additional mechanical or hydraulic setting mechanisms. Swellable packers may include a swellable material that increase in volume upon contact with a water- or oil-based fluid depending on the selected swellable material. Depending upon the types of fluids and swellable materials used, the swelling process may increase the volume of a packer by as much as several hundred percent.

In some embodiments, degradable polymer composites may be used to make wear-resistant, protective pockets or encapsulation for electronics, devices, and sensors. For example, degradable polymer composites may encapsulate a device or sensor downhole, and then degrade upon contact with aqueous fluids downhole, exposing the encapsulated device or sensor, and allowing operation.

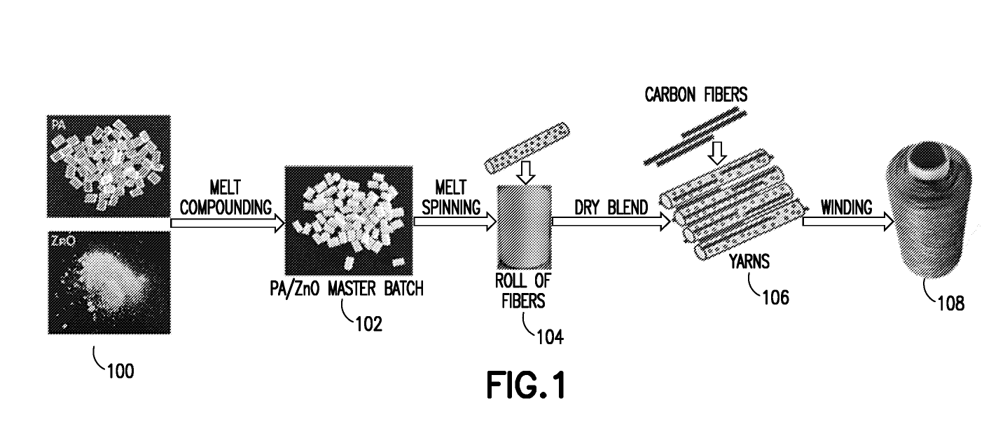

In some embodiments, the catalysts may be compounded with the reinforced resin before manufacturing the final desired shape or tool by processes such as filament winding, resin transfer molding, hand lay-up, hand spray-up, injection molding, compression molding, or extrusion. With particular respect to FIG. 1, one possible method for incorporating internal catalysts in accordance with the present disclosure is shown. In the method, degradable polymer composites are prepared having an internal catalyst to tune the rate of degradation and, in some cases, stretch-broken or continuous carbon fibers as structural reinforcement where desired. At 100, internal catalysts may be compounded into the degradable polymer matrix through melt compounding to produce a polymer/catalyst resin 102. The resin may then be processed into a fibrous material 104 by melt spinning or other techniques known in the art. When the incorporation of carbon fibers or other mechanical reinforcement is desired, fibers may be incorporated by dry blending to produce degradable polymer composite yarns 106, which may then be wound into polymeric sheets 108, resin pellets, or other convenient formats for distribution.

### Degradable Polymers

Degradable polymer composites in accordance with the present disclosure are polymers that have an internal catalyst embedded within the polymer that accelerates hydrolytic degradation of the polymer when water invades pores formed between neighboring chains of the continuous polymer matrix and activates the catalyst.

While degradable polymers may contain hydrolysable bonds in the backbone chain that react with water and degrade the physical structure of the polymers at elevated temperatures or at pH extremes, internal catalysts may be added to modify this process, allowing for controllability of degradation rates. Degradable polymer composites containing internal catalysts in accordance with the present disclosure may possess acceptable transient mechanical properties for the specific application, and, when exposed to aqueous fluids, degrade or dissolve away. Such degradable polymer composites may have appeal in oilfield exploration and production due to the potential time- and cost-savings associated with obviating the need to drill out or retrieve devices downhole. For example, a degradable polymer composite may be used to form a downhole tool, or a portion of a tool, and when employed the tool will function as required and when contacted with connate or injected aqueous fluids may degrade over a pre-determined time such that the wellbore operation is completed at the point that the polymer composite device loses mechanical integrity.

In one or more embodiments, degradable polymers may be used to form the matrix or continuous phase of the degradable polymer composites. In some embodiments, degradable polymers may include thermoplastic composites containing hydrolysable chemical bonds in the polymer chains, such as polyamide (PA), polyamideimide (PAI) and polyester (PET).

In one or more embodiments, degradation of the material may be tuned by increasing or decreasing the number of hydrolyzable bonds in the constituent polymers of the degradable material. Hydrolyzable bonds react with water through nucleophilic displacement, resulting in the formation of a new covalent bond with a hydroxyl (OH) group that displaces the previous bond and produces a leaving group. In some embodiments, deterioration/loss of mechanical strength of a degradable material may be the result of hydrolytic bond cleavage that results in disintegration into shorter chain polymers and monomers. Degradable polymer composites in accordance with the present disclosure may include polymers, copolymers, and higher order polymers having hydrolyzable bonds incorporated in one or more polymer chains. Examples of hydrolyzable bonds include esters, amides, urethanes, anhydrides, carbamates, ureas, and the like.

Degradable polymers in accordance with the present disclosure may include polymers, copolymers, and higher order polymers (such as terpolymers and quaternary polymers), and blends of various types of polymers. In one or more embodiments, polymer systems may exhibit primarily crystalline or amorphous character, and exhibit either melt or glass transition behavior respectively.

Due to relatively strong intermolecular forces, crystalline and semicrystalline polymers resist softening and the elastic modulus for these materials normally changes at temperatures above the melting temperature (Tm). Amorphous polymers on the other hand, undergo a reversible transition that when exposed to increasing temperature referred to as a “glass transition.” Similarly, “glass transition range” describes the temperature range in which the viscous component of an amorphous phase within a polymer increases and the observable physical and mechanical properties undergo a change as the amorphous phase begins to enter a molten or rubber-like state. Below the glass transition range characteristic to a given polymer, the amorphous phase of a polymer is in a glassy state that is hard and fragile. However, under an external force, amorphous polymers may still undergo reversible or elastic deformation and permanent or viscous deformation. Another useful metric is the glass transition temperature (Tg) in which the slope of the curve of the specific volume as a function of temperature for the material increases during the transition from a glass to liquid.

In one or more embodiments, degradable polymer composites may include block copolymers, which may contain both crystalline and amorphous domains. Because most polymers are incompatible with one another, block polymers may “microphase separate” to form periodic structures in which one fraction of the polymer remains amorphous, allowing polymer chains to mix and entangle, while a second fraction may interlock to form crystalline structures.

In one or more embodiments, degradable polymers may include polyester amides (PEA); polyetheresteramide (PEEA); polycarbonateesteramides (PCEA); polyether-block-amides such as those prepared from polyamide 6, polyamide 11, or polyamide 12 copolymerized with an alcohol terminated polyether; polyphthalamide; copolyester elastomers (COPE); thermoplastic polyurethane elastomers prepared from polyols of poly(ethylene adipate) glycol, poly(butylene-1,4 adipate) glycol, poly(ethylene butylene-1,4 adipate) glycol, poly(hexamethylene-2,2-dimethylpropylene adipate) glycol, polycaprolactone glycol, poly(diethylene glycol adipate) glycol, poly(hexadiol-1,6 carbonate) diol, poly(oxytetramethylene) glycol); and blends of these polymers. Other examples of commercially available polymer products suitable for use as a degradable material include Hytrel® polymers (DuPont®), Vestamid® E (Evonik), Texin®, Desmoflex®, Desmovit®, Desmosint® (Bayer), Carbothane™ TPU, Isoplast® ETPU, Pellethane® TPU, Tecoflex™ TPU, Tecophilic™ TPU, Tecoplast™ TPU, Tecothane™ TPU (Lubrizol), Rilsan® HT, Arnitel® (DSM®), Solprene® (Dynasol®), Engage® (Dow Chemical®), Dryflex® and Mediprene® (ELASTO®), Kraton® (Kraton Polymers®), Pibiflex®, Forprene®, Sofprene®, Pebax®, and Laprene®. In other possible embodiments, degradable polymer composites may be mixed with other polymers such as rubbers, thermoplastics, or fillers to form composites and blends.

Examples of degradable polymers in accordance with the present disclosure also include aliphatic polyesters, poly(lactic acid) (PLA), poly(c-caprolactone), poly(glycolic acid) (PGA), poly(lactic-co-glycolic acid), poly(hydroxyl ester ether), poly(hydroxybutyrate), poly(anhydride), polycarbonate, poly(amino acid), poly(ethylene oxide), poly(phosphazene), polyether ester, polyester amide, polyamides that include any type of Nylon, which includes, but is not limited to, Nylon 6, Nylon 6/6, Nylon 6/12, etc., as well as the blends of different types of Nylons and the blends of Nylon with other polymers, sulfonated polyesters, poly(ethylene adipate), polyhydroxyalkanoate, poly(ethylene terephtalate), poly(butylene terephthalate), poly(trimethylene terephthalate), poly(ethylene naphthalate) and copolymers, blends, derivatives or combination of any of these degradable polymers.

In one or more embodiments, degradable polymers may also be manufactured to contain other additives that provide specific mechanical properties to the matrix polymer on the basis of the desired use. Additives dispersed throughout the polymer may modify mechanical properties such as the flexibility or stiffness of the matrix polymer. Polymer composite additives may include particulate or fiber additives such as glass fibers, carbon fibers, aramid fibers, metal fibers, ceramic fibers, and boron fibers.

In some embodiments, degradation times may be adjusted by increasing or decreasing the porosity of the degradable matrix polymer and/or adjusting the loading of the internal catalyst. Porosity of the matrix polymer may be adjusted to enhance or limit access of free water into the pores of the matrix polymer in order to tune the degradation rate. Modification of the matrix polymer porosity may be achieved in some embodiments by introducing chemical crosslinkers to create additional links between the chains of the matrix polymer to decrease the observed porosity. Porosity of a polymeric composite may also be increased similarly by methods known in the art such as the use of blowing agents or pneumatogens.

In some embodiments, the internal catalyst may be selected on the basis of the exothermic activity of the hydration reaction of the catalyst. For example, hydration of the catalyst may increase the temperature and thereby the hydrolysis rate and/or participate as a catalyst to the underlying hydrolysis reaction between the aqueous fluid and the polymer matrix.

The loading of the catalysts into the polymer matrix may range from a percent weight internal catalyst by weight of polymer (wt %) of 1 wt % to 30 wt % of the total weight of the polymer in some embodiments, or from 2 wt % to 25 wt % in other embodiments. In some embodiments, the degradable polymer composites may contain one or more internal catalysts that may be present in an amount that ranges from a lower limit selected from the group of 1, 2.5, 5, and 10 parts per hundred of degradable polymer (phr), to an upper limit selected from the group 10, 15, 20, and 40 phr, where the concentration may range from any lower limit to any upper limit. The amount needed will vary, of course, depending upon the type of degradable polymer selected, type of internal catalyst, type of shape of the degradable polymer composite, and temperature conditions.

### Internal Catalysts

Internal catalysts in accordance with the present disclosure may be incorporated into the degradable polymer during manufacture and, when exposed to aqueous fluids, may contact the aqueous fluids that are absorbed into the matrix of the degradable polymer. Once the degradable polymer composite comes into contact with aqueous fluids, the internal catalyst is activated and begins to accelerate degradation of the polymer composite by eroding surrounding polymer matrix.

In one or more embodiments, internal catalysts may be salts of acid or bases capable of hydrolyzing chemical bonds in the structure of the polymer matrix. For example, carbon dioxide, HCl, NaOH, ZnCl₂, and AlCl₃ have been shown to accelerate the hydrolysis of degradable polymers in aqueous fluids.

In some embodiments, the internal catalysts may be Lewis acid-type complexes that may interrupt the hydrogen bonding between polyamide chains and accelerate the hydrolysis of the amide bonds. These catalysts include but are not limited to TiCl₄, FeCl₃, ZnCl₂, ZrCl₂, AlCl₃, GaCl₃, BCl₃, ZnF₂, LiCl, MgCl₂, AlF₃, SnCl₄, SbCl₅, SbCl₃, HfCl₄, ReCl₅; ScCl₃, InCl₃, BiCl₃; NbCl₅, MoCl₃, MoCl₅, SnCl₂, TaCl₅, WCl₅, WCl₆, ReCl₃, TlCl₃; SiCl₄, FeCl₂, CoCl₂, CuCl, CuCl₂, GeCl₄, YCl₃, OsCl₃, PtCl₂, RuCl₃, VCl₃, CrCl₃, MnCl₂, NiCl₂, RhCl₃, PdCl₂, AgCl, CdCl₂, IrCl₃, AuCl, HgCl₂, HgCl, PbCl₂, sodium borate, sodium pentaborate, and sodium tetrab orate.

Internal catalysts in accordance with the present embodiments may also be bases or base precursors that could accelerate the amide hydrolysis in aqueous fluids. In some embodiments, internal catalysts may be of the formula MX where M represents a divalent metal of one of the Periodic Table Groups 2, 8, 9, 10, 11, 12, and mixtures thereof; and X represents oxygen, hydroxide, or halide. Internal catalysts may also be metal oxides that include, but are not limited to, Ca(OH)₂, Mg(OH)₂, CaCO₃, Al(OH)₃, MgO, CaO, ZnO, CuO, Fe₂O₃, Al₂O₃, and the like.

Internal catalysts in accordance with the present disclosure may also include polymeric solid acids that can be compounded with polyamides to form polymer blends. The slow release of acid from the solid acid could accelerate the hydrolysis of polyamides when in downhole conditions. The examples of the solid acids include but are not limited to polyesters, polyacids (polystyrenesulfonic acid, polyacrylic acids, etc.), silica supported or zeolite-supported metal halides, silica supported heteropolyacids such as H₃PW₁₂O₄₀, H₄SiW₁₂O₄₀, H₃PMo₁₂O₄₀, and H₄SiMo₁₂O₄₀, polymer supported metal halides such as PVOH or polystyrene supported metal halides, silica supported other acid and base. In some embodiments, internal catalysts may include commercially available polymeric solid acids such as SiliaBonor Aluminum Chloride, SiliaBond® Amine, SiliaBonor Pyridine, and SiliaMetS® TAAcOH, commercially available from SILICYCLE, Inc. (Quebec, Canada).

In some embodiments, internal catalysts may be combined with a degradable polymer as a fiber or particulate having a length (or diameter for spherical or approximately spherical particles) having a lower limit equal to or greater than 10 nm, 100 nm, 500 nm, 1 μm, 5 μm, 10 μm, 100 μm, 500 μm, and 1 mm, to an upper limit of 10 μm, 50 μm, 100 μm, 500 μm, 800 μm, 1 mm, and 10 mm, where the length (or diameter for spherical or approximately spherical particles) of the internal catalyst may range from any lower limit to any upper limit.

In the degradable composites, small amounts of other additives or polymers such as compatibilizers, plasticizers, fire retardants, anti-microbials, pigments, colorants, lubricants, UV stabilizers, dispersants, nucleation agents, etc. used in the plastic processing industry may be added to modify the composite's characteristics and process capability according to the desired use.

### EXAMPLES

In the following examples, degradable polymeric composites containing various internal catalysts are assayed to determine degradation behavior in the presence of aqueous fluids. The examples are presented to illustrate the preparation and properties of degradable polymer composites and should not be construed to limit the scope of the disclosure, unless otherwise expressly indicated in the appended claims.

### Example 1

### ZnCl₂ as an Internal Catalyst

Samples were prepared from anhydrous ZnCl₂ compounded with PA6, a degradable polyamide, at 5 parts per hundred (phr), 11 phr and 29 phr, at 230° C. using a lab scale twin screw compounder (Minilab from Thermo Fisher Scientific (Waltham, Mass.)). The resulting polymer pellets were subjected to tests for thermal stability using thermogravimateric analysis (TGA), crystallinity using differential scanning calorimetry (DSC) under N₂, attenuated total reflectance Fourier transform infrared spectroscopy (ATR-FTIR), and degradation.

The degradable polyamide PA6 is a thermoplastic with extensive hydrogen-bonding between the amide bonds, which provides desirable mechanical properties and workability. PA6 composites are potentially degradable in aqueous fluids through amide bond hydrolysis. However, hydrolysis of PA6 and similar polyamides in water is slow, and degradation (as determined by loss of weight and mechanical strength) within a reasonably short period of time requires temperatures above 110° C. Additionally, the degradation kinetics of the polyamide is complicated by competing reverse condensation reactions that occur under the same conditions as degradation.

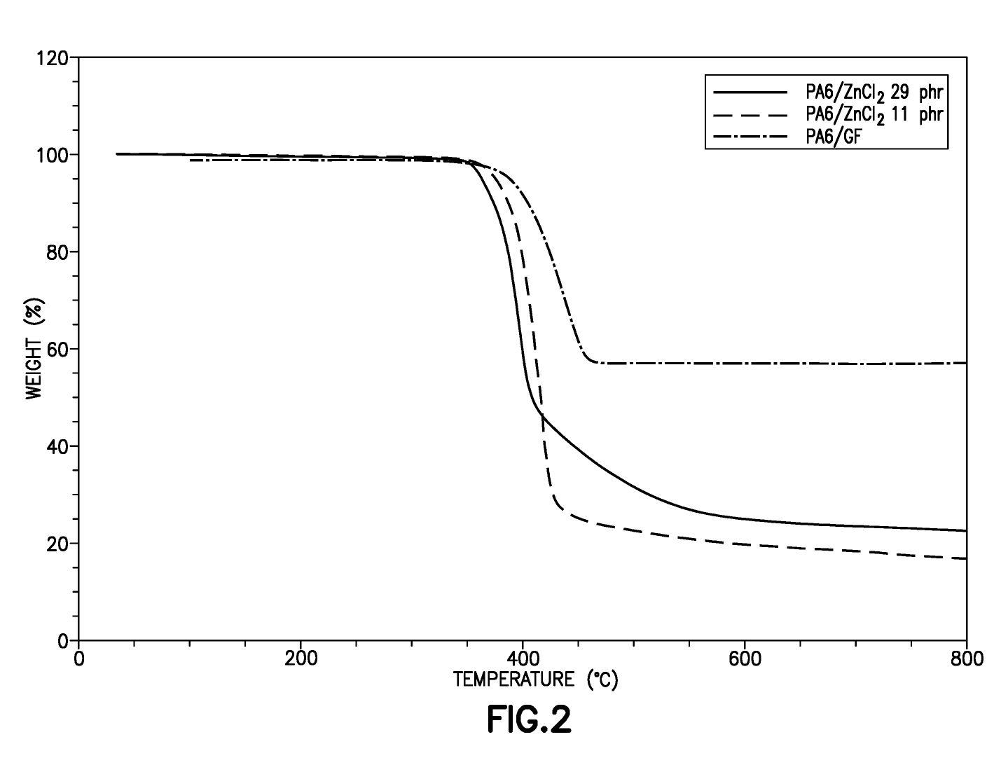

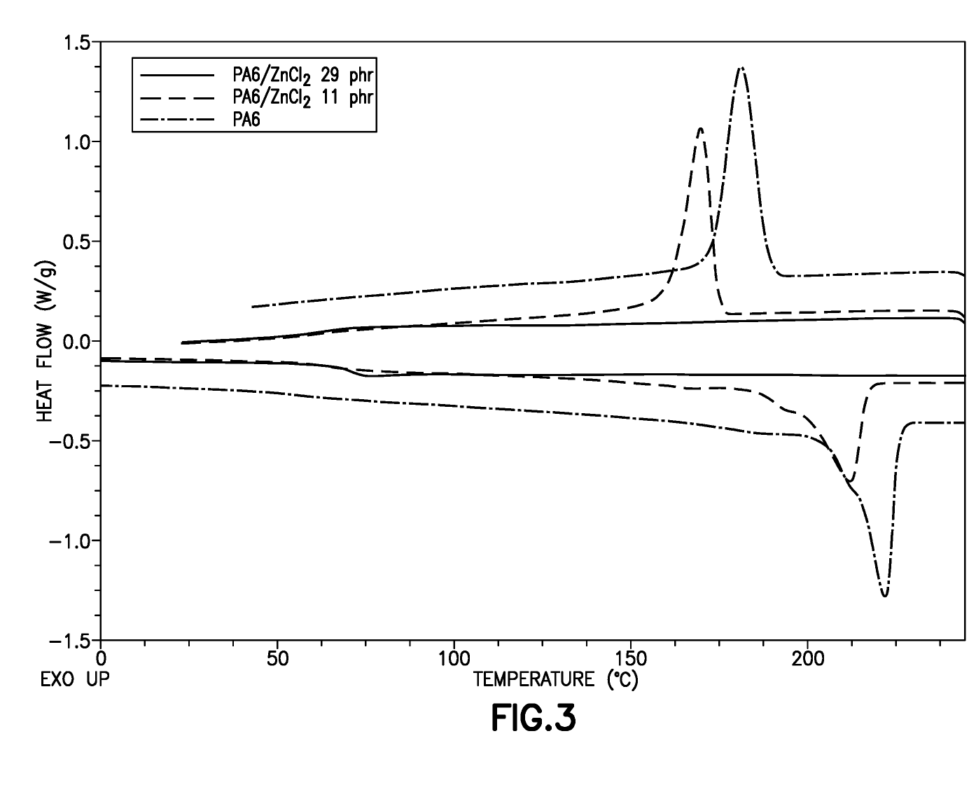

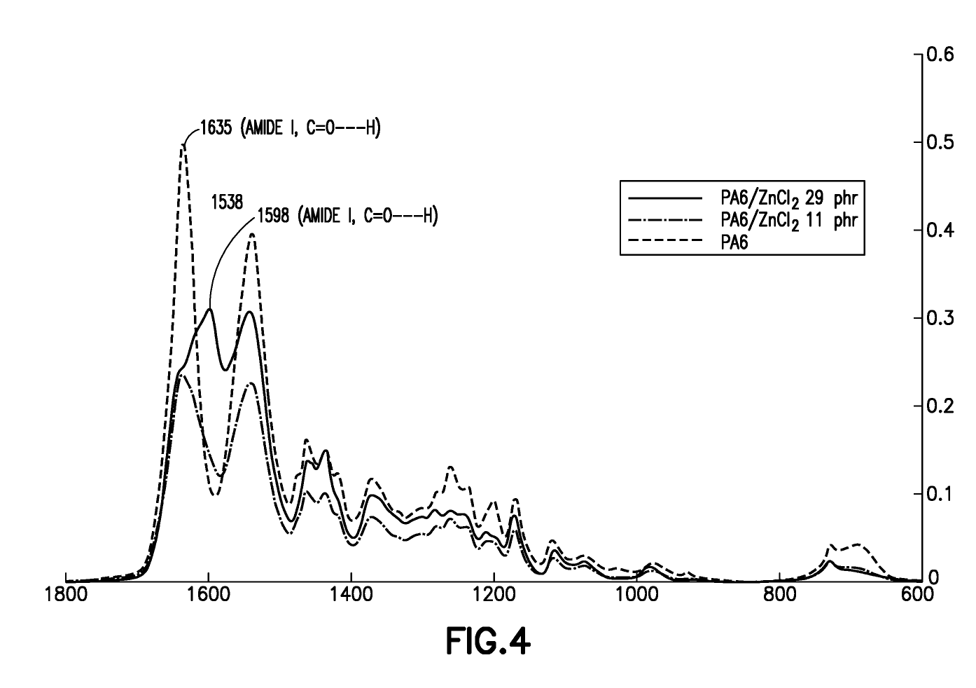

As shown in FIG. 2, the thermal stability (onset of weight loss) of PA6/ZnCl₂ composites at the ZnCl₂ loading of 11 phr and 29 phr is comparable to that of glass fiber reinforced PA6. However, the crystallinity of the composites decreases with decreasing melting point as the loading of ZnCl₂ increases, and the PA6/ZnCl₂ phase with 29 phr ZnCl₂ is amorphous as its DSC trace has no crystalline peaks as shown in FIG. 3. With particular respect to FIG. 4, the FTIR spectra show the shift of the amide I peak from 1635 for pure PA6 to 1598 for PA6/ZnCl₂ (29 phr), indicating the interruption of the hydrogen bonding by ZnCl₂.

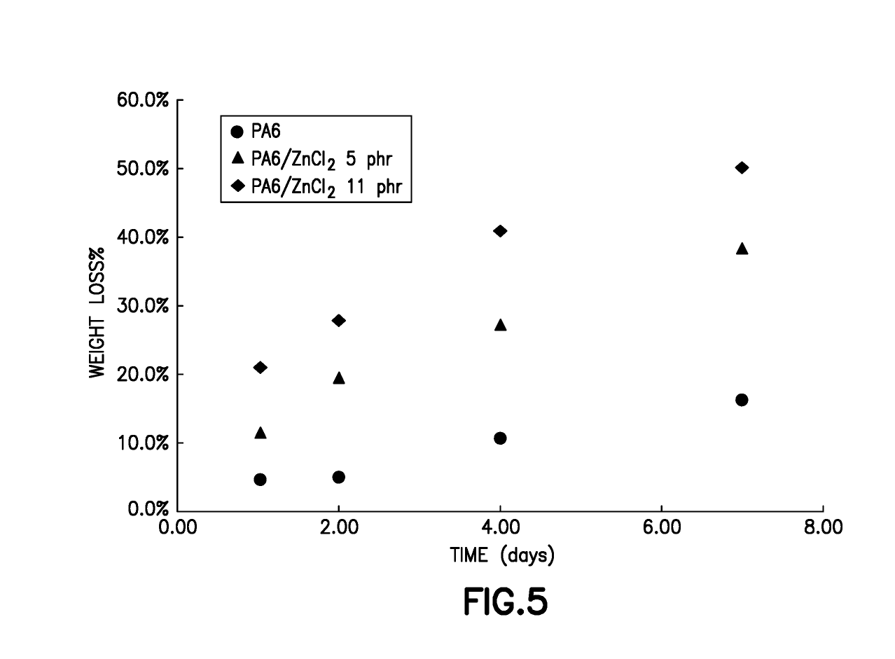

Next, the degradation of PA6/ZnCl₂ composites was conducted in deionized (DI) water at 150° C., and compared with the degradation of pure PA6 under the same conditions. The weight loss of the materials over time was recorded for the samples, and the PA6/ZnCl₂ samples containing the internal catalyst exhibited faster degradation rates that the comparative PA6 samples. With particular respect to FIG. 5, higher loadings of the ZnCl₂ internal catalyst resulted in more weight loss at 150° C.

### Example 2

### AlF₃ as the Internal Catalyst

In the next example, degradable polymer composites containing AlF₃, an ionic compound with a melting point over 1000° C., were studied. Anhydrous powdered AlF₃ was compounded into PA6 resin at 8% by weight of polymer and at 230° C. using the Minilab compounder.

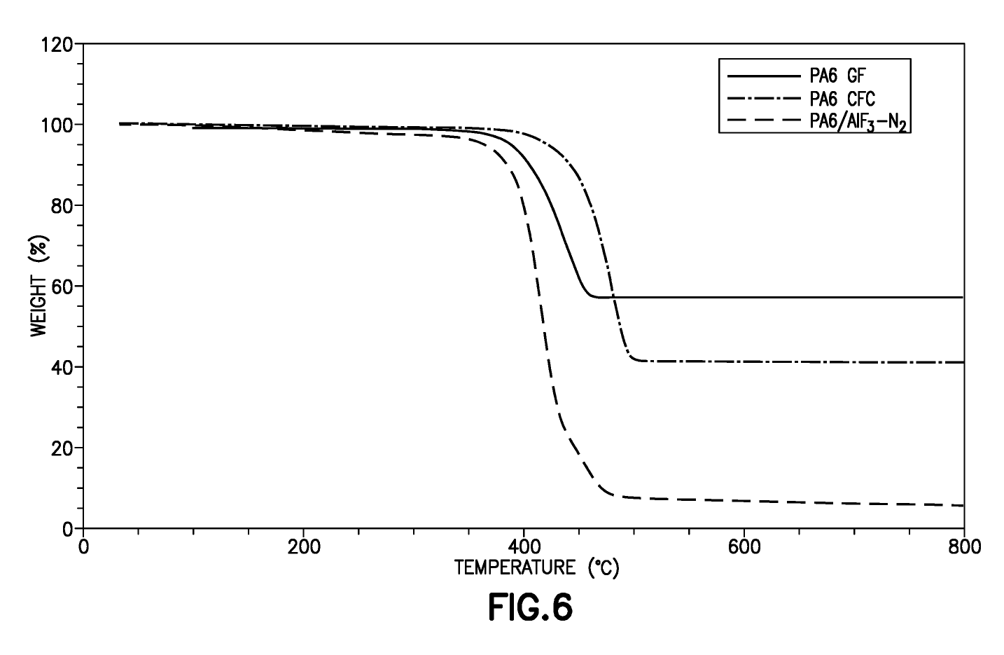

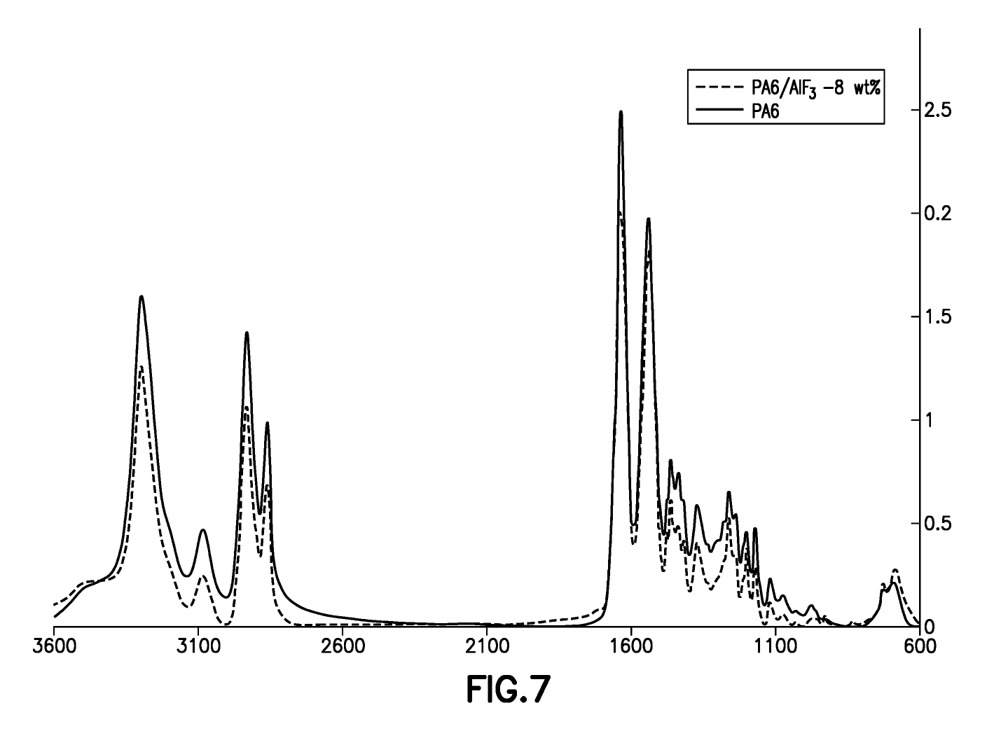

With particular respect to FIG. 6, TGA data show that the thermal stability (onset of weight loss) of PA6/AlF₃ is comparable to that of glass (GF) or carbon fiber (CFC) reinforced PA6. DSC data (not shown) indicated that the crystallinity of the as-compounded pellets was 26%, slightly lower than 27.9% for pure PA₆, which indicates that AlF₃ has little impact on the morphology of PA6. With respect to FIG. 7, the FTIR spectrum of PA6/AlF₃ is almost identical to that of pure PA6, signifying little interaction between AlF₃ and the functional groups on the constituent polymer chains of the polyamide.

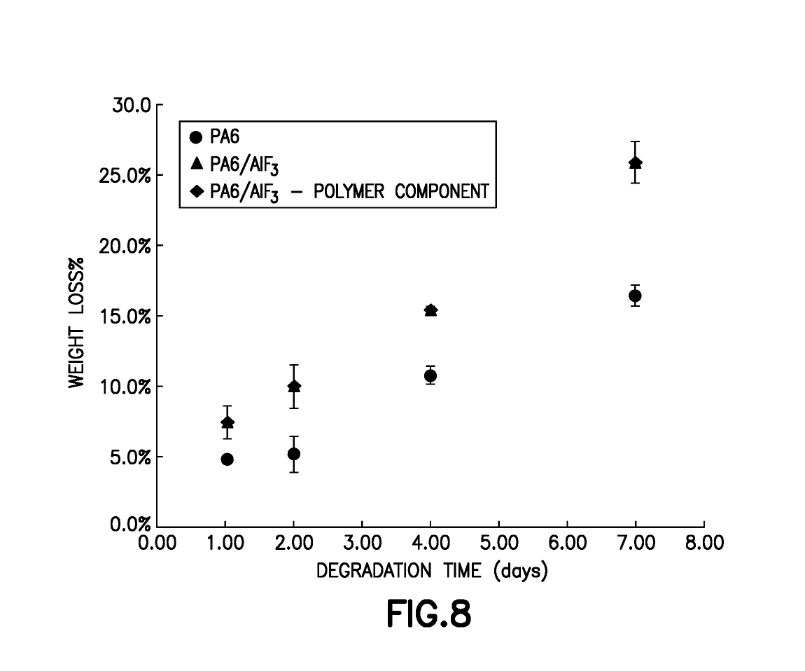

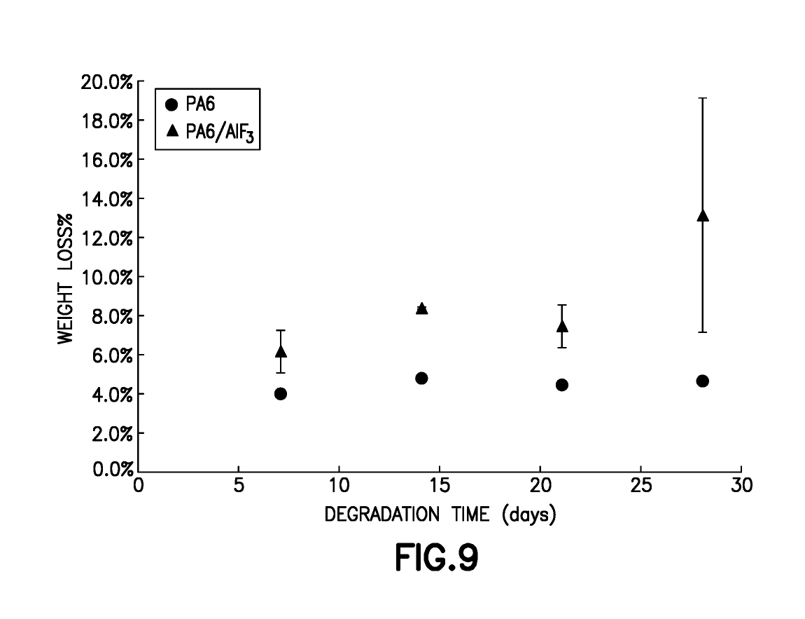

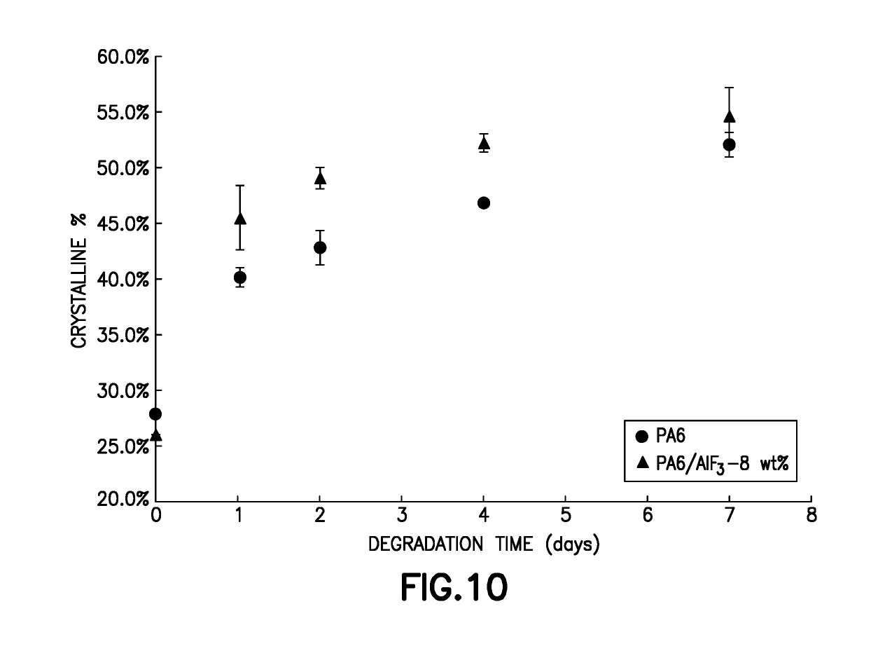

With respect to FIG. 8, PA6/AlF₃ loses more weight than pure PA6 does when degraded in water at 150° C., and most of the weight loss can be attributed to the loss of polyamide and not AlF₃ dissolution. The same trend is displayed for degradation at 98° C. as shown in FIG. 9, with more weight loss associated with PA6/AlF₃ than with pure PA6. As the degradation proceeds, the crystallinity of the samples also increases, consistent with the fact that degradation occurs in the amorphous phase of polyamide as demonstrated in the change of crystallinity over time presented in FIG. 10.

### Example 3

### ZnO as the Internal Catalyst

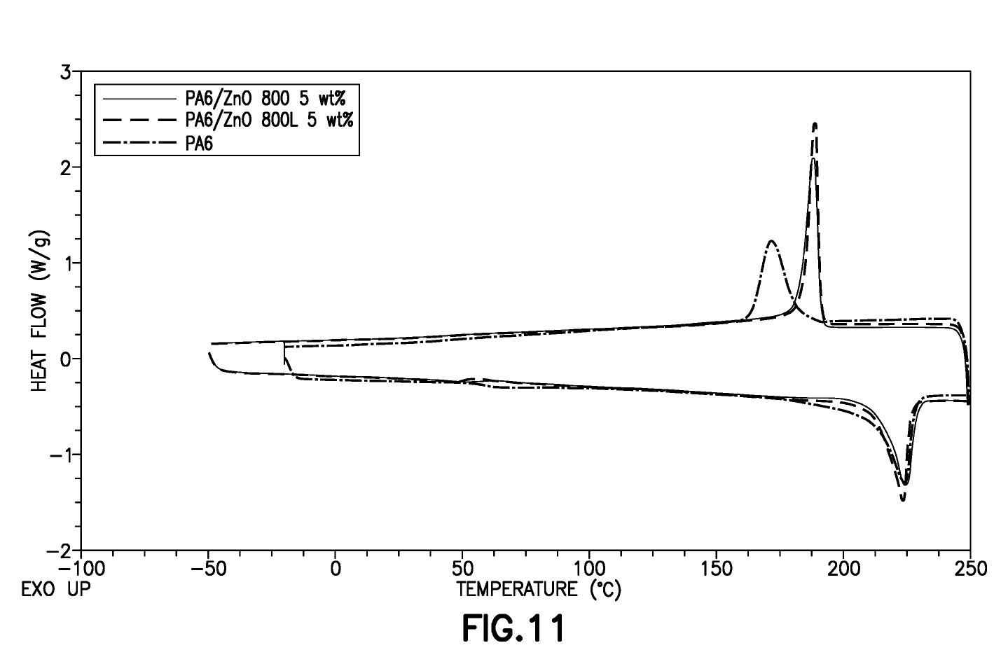

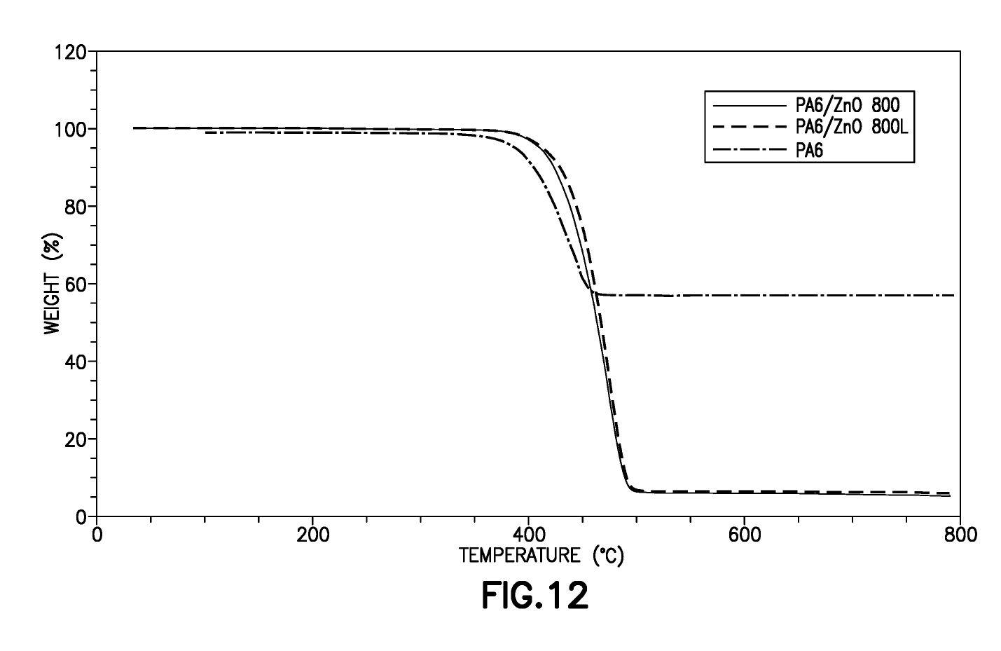

In the next example, two grades of ZnO where used to prepare degradable polymer composites. The ZnO used was 800 and 800L, commercially available from Zinc Oxide, LLC (Dickinson, Tenn.). ZnO catalysts were compounded with PA6 at 230° C. using the lab scale Minilab twin screw compounder. Approximately 5% by weight of each grade was compounded into the PA6. DSC analysis (FIG. 11) and TGA (FIG. 12) were performed on the compounded samples and the tests revealed the thermal similarity between the PA6/ZnO compounds and pure PA6 and glass fiber-reinforced PA6.

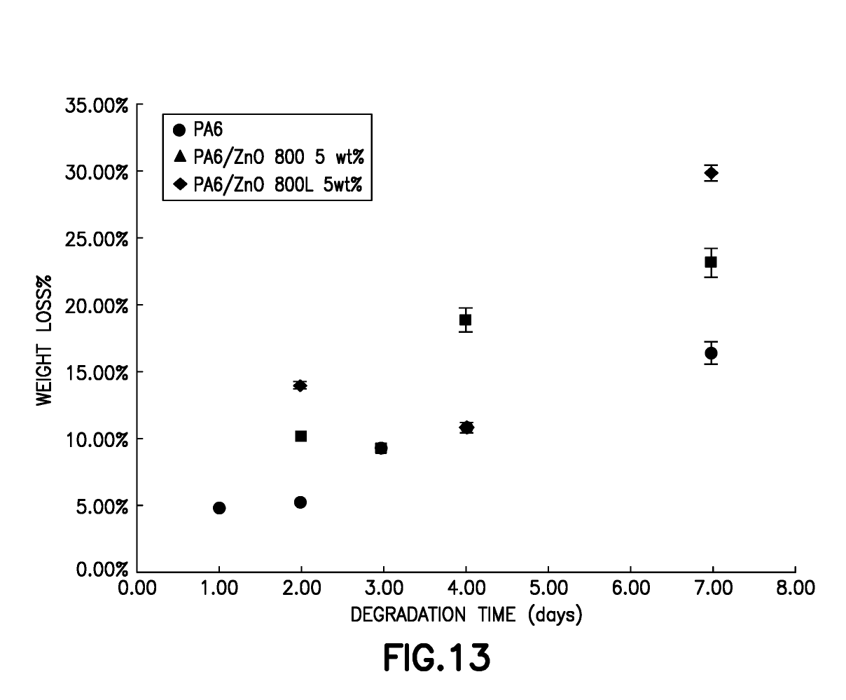

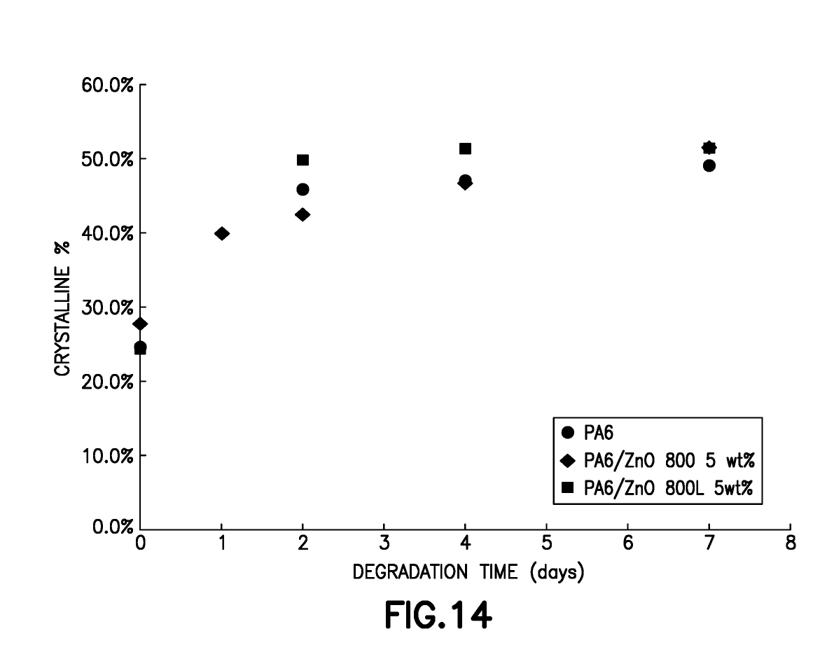

Degradation tests were conducted in DI water at 98° C., 120° C., and 150° C. Degradation at 150° C. demonstrates that the addition of ZnO results in dramatically higher weight loss than what occurs with pure PA6 (FIG. 13) and the sample itself becomes brittle after 7 days of degradation. As seen with other internal catalysts, the crystallinity of the PA6/ZnO compounds increases with increasing degradation time. FIG. 14 shows the percentage crystallinity of the samples compared with PA6 as degradation proceeds at 150° C.

Although only a few examples have been described in detail above, those skilled in the art will readily appreciate that many modifications are possible in the examples without materially departing from this subject disclosure. Accordingly, all such modifications are intended to be included within the scope of this disclosure as defined in the following claims.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A composition comprising:
a degradable polymer composite, wherein the degradable polymer composite comprises a matrix formed from one or more polymers blended with one or more internal catalysts.

2. The composition of claim 1, wherein the internal catalysts are one or more selected from a group consisting of: TiCl₄, FeCl₃, ZnCl₂, ZrCl₂, AlCl₃, GaCl₃, BCl₃, ZnF₂, LiCl, MgCl₂, AlF₃, SnCl₄, SbCl₅, SbCl₃, HfCl₄, ReCl₅; ScCl₃, InCl₃, BiCl₃; NbCl₅, MoCl₃, MoCl₅, SnCl₂, TaCl₅, WCl₅, WCl₆, ReCl₃, TlCl₃; SiCl₄, FeCl₂, CoCl₂, CuCl, CuCl₂, GeCl₄, YCl₃, OsCl₃, PtCl₂, RuCl₃, VCl₃, CrCl₃, MnCl₂, NiCl₂, RhCl₃, PdCl₂, AgCl, CdCl₂, IrCl₃, AuCl, HgCl₂, HgCl, PbCl₂, sodium borate, sodium pentaborate, and sodium tetraborate.

3. The composition of claim 1, wherein the one or more internal catalysts are at least one of ZnCl₂ or AlF₃.

4. The composition of claim 1, wherein the one or more internal catalysts are selected from a group consisting of: Ca(OH)₂, Mg(OH)₂, CaCO₃, Al(OH)₃, MgO, CaO, ZnO, CuO, Fe₂O₃, and Al₂O₃.

5. The composition of claim 1, wherein the one or more internal catalysts are polymeric solid acids.

6. The composition of claim 1, wherein the concentration of the one or more internal catalysts is in the range of 2 wt % to 30 wt %.

7. The composition of claim 1, wherein the one or more internal catalysts are particulate and wherein the particulates have a size that ranges from 10 μm to 1 mm.

8. The composition of claim 1, wherein the one or more polymers are one or more selected from a group consisting of: polyamide, polyamideimide, and polyester.

9. The composition of claim 1, wherein the one or more polymers are polyamide.

10. The composition of claim 1, wherein the degradable polymer composite further comprises one or more selected from a group consisting of: glass fibers, carbon fibers, aramid fibers, metal fibers, ceramic fibers, and boron fibers.

11. A method of using a degradable polymer composite in a wellbore the method comprising:
emplacing a degradable polymer composite in a wellbore traversing a subterranean formation, wherein the degradable polymer composite comprises a matrix formed from one or more polymers blended with one or more internal catalysts; and
contacting the degradable polymer composite with an aqueous fluid; and
allowing the degradable polymer composite to at least partially degrade.

12. The method of claim 11, wherein the internal catalysts are one or more selected from a group consisting of: TiCl₄, FeCl₃, ZnCl₂, ZrCl₂, AlCl₃, GaCl₃, BCl₃, ZnF₂, LiCl, MgCl₂, AlF₃, SnCl₄, SbCl₅, SbCl₃, HfCl₄, ReCl₅; ScCl₃, InCl₃, BiCl₃; NbCl₅, MoCl₃, MoCl₅, SnCl₂, TaCl₅, WCl₅, WCl₆, ReCl₃, T1Cl₃; SiCl₄, FeCl₂, CoCl₂, CuCl, CuCl₂, GeCl₄, YCl₃, OsCl₃, PtCl₂, RuCl₃, VCl₃, CrCl₃, MnCl₂, NiCl₂, RhCl₃, PdCl₂, AgCl, CdCl₂, IrCl₃, AuCl, HgCl₂, HgCl, PbCl₂, sodium borate, sodium pentaborate, and sodium tetraborate.

13. The method of claim 11, wherein the internal catalysts are one or more polymeric solid acids.

14. The method of claim 11, wherein the one or more internal catalysts are at least one of ZnCl₂ or AlF₃.

15. The method of claim 11, wherein the one or more internal catalysts are selected from a group consisting of: Ca(OH)₂, Mg(OH)₂, CaCO₃, Al(OH)₃, MgO, CaO, ZnO, CuO, Fe₂O₃, and Al₂O₃.

16. The method of 11, wherein the concentration of the one or more internal acids is in the range of 1 to 20 phr of the one or more polymers.

17. The method of claim 11, wherein the one or more internal catalysts are particulate and wherein the particulates have a size that ranges from 10 μm to 1 mm.

18. The method of claim 11, wherein the one or more polymers are one or more selected from a group consisting of: polyamide, polyamideimide, and polyester.

19. The method claim 11, wherein the degradable polymer composite comprises all or a part of a downhole tool selected from a group consisting of: ball sealers, packers, straddle-packer assemblies, bridge plugs, frac plugs, darts, drop balls, seats, and loading tubes for perforating guns.

20. The method of claim 11, wherein the degradable polymer composite further comprises one or more selected from a group consisting of: glass fibers, carbon fibers, aramid fibers, metal fibers, ceramic fibers, and boron fibers.

21. A method of manufacturing a degradable polymer composite comprising:
compounding one or more internal catalysts with one or more degradable polymer resins; and
forming a degradable polymer composite by at least one of injection molding, filament winding, resin transfer molding, hand lay-up, hand spray-up, compression molding, or extrusion, wherein the degradable polymer composite comprises a matrix formed from one or more polymers blended with one or more internal catalysts.
